(19) United States
(12) Patent Application Publication
(10) Pub. No.: US 2025/0119409 A1
(43) Pub. Date: Apr. 10, 2025

(54) PROTECTING USER PRIVACY AND AD-BLOCKING USING A SOFTWARE GATEWAY

(71) Applicant: LOOKOUT, INC., Boston, MA (US)

(72) Inventors: Rama Saritha Chadalavada, San Jose, CA (US); Tyler Croak, Columbia, MD (US); Abhijit Bhadra, Hyderabad (IN); Joel Perkins, Salem, MA (US); Brian James Buck, Livermore, CA (US)

(73) Assignee: LOOKOUT, INC., Boston, MA (US)

(21) Appl. No.: 18/481,135

(22) Filed: Oct. 4, 2023

(51) Int. Cl. H04L 9/40; G06F 21/62; H04L 67/56

(52) U.S. Cl. CPC H04L 63/0281; G06F 21/6263; H04L 63/20; H04L 67/56

(57) ABSTRACT

Methods and systems for using a software gateway to improve enterprise user privacy for network communication data are described. A server executing the software gateway may receive a request for network communication data via several described pathways, including a software client on the client device, a proxy auto-configuration module, and a reverse proxy server. The software gateway may receive the network communication data, which is then forwarded to a proxy server, where the proxy server executes software modules included within the network communication data to generate expanded network data. The software gateway server may then filter the expanded network data by applying a set of content identification rules. Each content identification rule may specify data that is not passed to the client device. Only the portion of the executed network data allowed by the set of content identification rules may then be transmitted back to the software client.

### TECHNICAL FIELD

The claimed subject matter relates generally to the field of network communications and more specifically to enhancing privacy and security for multiple forms of network traffic at an enterprise level.

### BACKGROUND

Privacy is increasingly a concern not just for users but also for enterprises. Internet ads or online ads are one of the major issues that users come across while performing day-to-day tasks on the internet. These ads are not only taxing to hardware processors and operating system resources, they also act as a hindrance for productivity, efficiency and user focus. Additionally, these ads are often used as a phishing channel for the user to click to take them to malicious content or websites. Even when ads that do not have malicious intent, they are often not customized to users and often a waste of resources. Additionally, these ads do not respect privacy laws and are non-compliant to evolving privacy regulations.

Ad blocker software is conventionally implemented as open-source browser extensions that can block web ads. Current browser extension and network appliance-based ad-blocking solutions require highly privileged access to read and modify all traffic in a browser or are limited to a single network location/virtual private network (VPN) concentrator. There is also privacy-enhancing software available as a browser extension that stops usage tracking, analytics, cookies etc., which, while not strictly falling within the definition of online ads, cause many similar issues. However, these capabilities are available as browser extensions and do not work for cloud applications and other network channels. Furthermore, there is a need for organizations to have control over what sites are and are not blocked for their users, instead of allowing one open-source developer or an open source community to have sole control over the organization's employees' browsing experiences. Also, coming changes in browser extension behavior will reduce the capabilities and effectiveness of these ad blockers, thus a solution which solves things differently.

A trusted solution, that is cloud delivered, and ability to centralized administration would be desirable to enterprise network technology administrators. Such a solution would preferably not only block ads, but also protect user privacy from cloud applications as well.

### SUMMARY

Methods and systems for using a software gateway to improve enterprise user privacy for network communication data are described. A server executing the software gateway may receive a request for network communication data from a specified web site, where the request is received from a network-based software client executing on a client device. The network communication data may include data from web sites, cloud-based web applications, and/or data center applications. The software client, based on the client device, may intercept network communication data requests from the client device. The software gateway may transmit the request for network communication data to the specified web site on the behalf of the client device, and receive the network communication data. The network communication data may then be forwarded to a proxy server using a network connection with the server executing the software gateway, where the proxy server loads the network communication data to generate expanded network data that includes all content elements of an interface displayable on a display of the client device.

The proxy server may then receive a set of content identification rules linked to the specified web site from the server executing the software gateway. The set of content identification rules may include individual rules provided by both an enterprise entity managing the server executing the software gateway and a user of the client device. Each content identification rule may specify data that is not passed to the client device, where the set of content identification rules, individually or collectively, specifies at least one of audiovisual content, advertisements, trackers, or cookies to be blocked the expanded network data via the network connection with the proxy server. The proxy server may apply the set of content identification rules to the expanded network data to remove the specified data from the specified web site. Only the portion of the expanded network data allowed by the set of content identification rules may then be transmitted back to the software gateway server, which may then forward the allowed portion of the expanded network data to the software client.

### BRIEF DESCRIPTION OF THE DRAWINGS

The embodiments are illustrated by way of example and not limitation in the figures of the accompanying drawings, in which like references indicate similar elements, and in which:

FIG. 1 illustrates a diagram of an example system for enterprise-level protection of user privacy using a software gateway in accordance with some embodiments.

FIG. 2 illustrates a block diagram of an electronic device in accordance with some embodiments of the disclosure.

FIG. 3 illustrates a block diagram of a system that uses a software gateway to protect user privacy at the enterprise level in accordance with some embodiments.

FIG. 4 illustrates a flow diagram of an example method of providing enterprise-level protection of user privacy using a privacy policy for a specified web site using a software gateway in accordance with some embodiments.

FIG. 5 illustrates a diagram of a system providing enterprise-level protection of user privacy using a software gateway based on several content identification rule configurations, in accordance with some embodiments of the disclosure.

FIG. 6 illustrates a flow diagram of an example method of providing enterprise-level protection of user privacy using different content retrieval policies for a specified web site using a software gateway in accordance with some embodiments.

FIG. 7 illustrates a flow diagram of an example method of providing enterprise-level protection of user privacy for user input data directed to a specified web site using a software gateway in accordance with some embodiments.

### DETAILED DESCRIPTION

Protecting privacy of users and organizational data and identity is addressed by the solutions described herein. Online tracking is used by many web sites to monitor information about the user of the web site, often to provide personalized advertising and/or content on the web site, in violation of the desires of users or Entities to not be tracked online. This is often done by recording user interactions with the web site, and combining this record of interactions (e.g., clicks, time spent on a particular web page, etc.) with user personal information (e.g., demographic information, location information, financial information) to create a profile for the user on the specified web site. Conventional ad-blocking technologies have difficulty distinguishing the use of third-party trackers (e.g., Google Analytics) legitimately by first party sites from privacy invasive cross-site trackers. Furthermore, the same data that could be willfully voluntarily granted by a user to one website might be something that is considered private with respect to another website. Accordingly, described herein are site-specific content identification rules, to identify which data should be granted by a user to the specified web site.

Furthermore, ad blocking is currently left up to the discretion of individual users, usually in the form of browser-based ad-ons or security preferences. However, there may be geopolitical situations that require improving privacy from an individual's choices, and even when working from home, some ad serving technologies seem to have access to private data. Data in which entities may have interest in having increased privacy may include user-specific private data (e.g., social security identifier, date of birth, address, phone number, email address, etc.) and metadata, such as browsing history data, which websites, user names, passwords, etc., which may be tracked passively using fingerprinting algorithms. Also, when an Enterprise has employees performing tasks on behalf of the Enterprise (for example, competitive information gathering about competitors of the company or research into new technologies which might be incorporated into new products to be offered in the future by the company), the very fact that the Enterprise has employees performing those activities may itself be considered private. This sort of identity information constitutes enterprise private information, as opposed to user private information, and is addressed by the use of content identification rules provided by an enterprise for the specified web site, thereby removing reliance upon the individual to protect the privacy of the data they provide and access on web sites.

As noted in the Summary, the software gateway may be used as an intermediary between the users, regardless of where their client devices are located, and requested network communication data from Internet and/or cloud applications, for example. The software gateway, which may be implemented as a secure web gateway (SWG) in some embodiments, may apply various content identification rules to block not just ads, but to enhance user privacy as well. The software gateway may have extensive security capabilities by using Phishing & Content Protection (PCP) engines and policy managers. The software gateway-enhanced system can not only enhance users' experiences, but reduce latency as well (by blocking trackers and ads, and thereby reducing network traffic).

The present disclosure may be implemented in numerous ways including, but not limited to, as a process, an apparatus, a system, a device, a method, or a computer readable medium such as a non-transitory computer readable storage medium containing computer readable instructions or computer program code, or a computer network wherein computer readable instructions or computer program code are sent over optical or electronic communication links. Applications, software programs or computer readable instructions may be referred to as components or modules. Applications may take the form of software executing on a general purpose computer or be hardwired or hard coded in hardware. Applications may also be downloaded in whole or in part through the use of a software development kit, framework, or toolkit that enables the creation and implementation of the present disclosure. Applications may also include web applications, which include components that run on the device in a web browser. In this specification, these implementations, or any other form that the disclosure may take, may be referred to as techniques. In general, the order of the steps of disclosed methods may be altered within the scope of the disclosure, except in those instances where it is specified that the order of steps must be in a particular sequence.

As used herein, the term “mobile communications device” may refer to mobile phones, PDAs and smartphones. The term “mobile communications device” may also refer to a class of laptop computers which run an operating system that is also used on mobile phones, PDAs, or smartphones. Such laptop computers are often designed to operate with a continuous connection to a cellular network or to the internet via a wireless link. The term “mobile communications device” excludes other laptop computers, notebook computers, or sub-notebook computers that do not run an operating system that is also used on mobile phones, PDAs, and smartphones. Specifically, mobile communications devices include devices for which wireless communications services such as voice, messaging, data, or other wireless Internet capabilities are a primary function.

As used herein, a “mobile communications device” may also be referred to as a “device.” “mobile device,” “mobile client,” “electronic device,” or “handset.” However, a person having skill in the art will appreciate that while the present disclosure refers to systems and methods being used on mobile communications devices, the present disclosure may also be used on other computing platforms including, but not limited to, desktop, laptop, notebook, netbook, or server computers.

As used herein, the term “client computer” may refer to any computer, embedded device, mobile device, or other system that can be used to perform the functionality described as being performed by the client computer. Specifically, client computers include devices which can be used to display a user interface by which the functionality provided by the server can be utilized by a user. Client computers may be able to display a web page, load an application, load a widget, or perform other display functionality that allows the client computer to report information from the server to the user and to receive input from the user in order to send requests to the server.

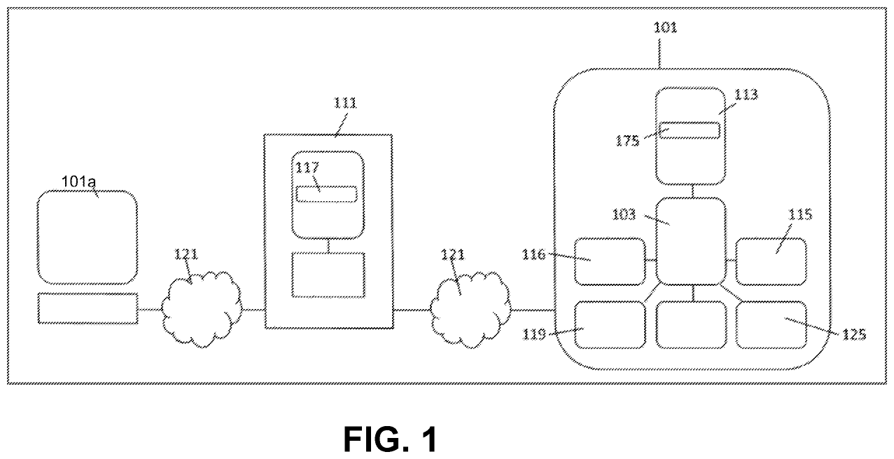

Prior to describing in detail systems and methods for enterprise-level protection of user privacy using a software gateway, a system in which the disclosure may be implemented shall first be described. Those of ordinary skill in the art will appreciate that the elements illustrated in FIG. 1 may vary depending on the system implementation.

As shown in FIG. 1, the system may include mobile communications devices 101, 101a and a server 111. An example mobile communications device 101 may include an operating system 113, an input device 115, a radio frequency transceiver(s) 116, a visual display 125, and a battery or power supply 119. Each of these components may be coupled to a central processing unit (CPU) 103. The mobile communications device operating system 113 runs on the CPU 103 and enables interaction between application programs and the mobile communications device hardware components. In some embodiments, the mobile communications device 101 receives data through an RF transceiver(s) 116 which may be able to communicate via various networks including, but not limited to, Bluetooth, local area networks such as Wi-Fi, and cellular networks such as GSM or CDMA.

In some embodiments, a local software component 175 is an application program that is downloaded to a mobile communications device and installed so that it integrates with the operating system 113. Much of the source code for the local software component 175 can be re-used between various mobile device platforms by using a cross-platform software architecture. In such a system, the majority of software functionality can be implemented in a cross-platform core module. The cross-platform core can be universal allowing it to interface with various mobile device operating systems by using a platform-specific module and a platform abstraction module that both interact with the mobile device operating system 113, which is described in U.S. Pat. No. 8,099,472, entitled “SYSTEM AND METHOD FOR A MOBILE CROSS-PLATFORM SOFTWARE SYSTEM,” incorporated herein by reference. In another embodiment, the local software component 175 can be device, platform or operating system specific.

The mobile communications device 101 may access a communications network 121 that permits access to a server 111. The server 111 may also be accessed by another mobile communications device 101a via network 121. The network 121 will normally be the Internet but can also be any other communications network. Alternatively, the mobile communications device 101 may access the server 111 by a different network than the network the other mobile communications device 101a accesses the server 111. In some embodiments, the server 111 is provided with server software 117. The server software 117 on the server 111 provides functionality to allow two-way communication between the server 111 and the mobile communications devices 101, 101a through the network 121. The server software 117 allows data, such as location-related information, pictures, contacts, videos, SMS messages, call history, event logs, and settings to be transferred from the mobile communications device 101 to the other mobile communications device 101a and vice versa.

It is understood by those of ordinary skill in the art that the functionality performed by server 111 does not necessarily have to be accomplished on a single hardware device. In this context, the use of the term server is intended to refer to one or more computers operating in cooperation or collaboration to provide the functionality described herein. The computers may be co-located or in different locations. The computers may inter-operate in such a way that portions of functionality are provided by separate services that may or may not be operated by the same entity as other computers which provide other functionality. For example, one set of servers may provide data storage functionality while another provides all other functionality. The data storage servers may be operated by a separate company than the servers that provide the other functionality. S3 (simple storage system), from Amazon, Inc. is such a data storage service which may be utilized by separate set of computers to enable the present invention.

It should be understood that the arrangement of electronic mobile communications device 101 illustrated in FIG. 1 is but one possible implementation and that other arrangements are possible. It should also be understood that the various system components defined by the claims, described below, and illustrated in the various block diagrams represent logical components that are configured to perform the functionality described herein. For example, one or more of these system components (and means) can be realized, in whole or in part, by at least some of the components illustrated in the arrangement of mobile communications device 101. In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 1. Other components may be implemented in software, hardware, or a combination of software and hardware. Moreover, some or all of these other components may be combined, some may be omitted altogether, and additional components can be added while still achieving the functionality described herein. Thus, the disclosure described herein can be embodied in many different variations, and all such variations known to those of ordinary skill are contemplated to be within the scope of what is claimed.

In the description that follows, the disclosure will be described with reference to acts and symbolic representations of operations that are performed by one or more devices, unless indicated otherwise. As such, it will be understood that such acts and operations, which are at times referred to as being computer-executed, include the manipulation by the processing unit of data in a structured form. This manipulation transforms the data or maintains it at locations in the memory system of the device, which reconfigures or otherwise alters the operation of the device in a manner well understood by those skilled in the art. The data structures where data is maintained are physical locations of the memory that have particular properties defined by the format of the data. However, while the disclosure is being described in the foregoing context, it is not meant to be limiting as those of skill in the art will appreciate that various of the acts and operation described hereinafter may also be implemented in hardware.

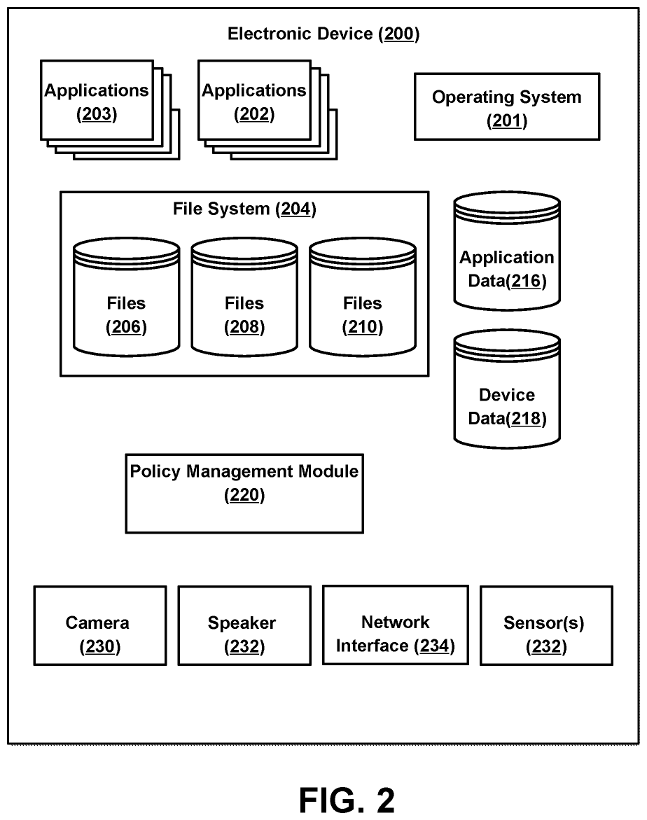

FIG. 2 illustrates a block diagram of an electronic device 200 in accordance with some embodiments of the disclosure. As shown in FIG. 2, the electronic device 200 may be configured to provide an execution environment to host at least one operating system 201, a plurality of applications 202 and 203, and a file system 204. In some embodiments, each of the plurality of applications 202 and 203 may include executable code, which when executed by a processor (e.g., CPU 103), may provide a service or function of the electronic device 200. Each of the plurality of applications 202 or 203 may be associated with at least a part of the application data 216.

In the same or alternative embodiments, one or more of the plurality of applications 202 or 203 may access any of the file system 204 comprising file sources 206, 208, and 210, application data 216, device data 218, camera 230, speaker 232, network interface 234, and sensor(s) 232. For example, the electronic device 200 may host or run a plurality of applications 202 and 203. A first application may access or retrieve data from application data 216 and file source 206 from the file system 204. A second application may access or retrieve data from the device data 218 and file sources 208 and 210 from the file system 204. Furthermore, a third application may retrieve data generated from the camera 230 and sensor(s) 232 and access the network interface 234. As such, each of the applications of the plurality of applications 202 and 203 may access various types of data or files stored on the electronic device 200 as well as a functionality (e.g., camera 230, speaker 232, network interface 234, sensor(s) 232) of the electronic device 200. In some embodiments, the electronic device 200 may also support the operation of a policy management module 220 that may be responsible for creating and assigning policies for the electronic device 200. In some embodiments, the policy management module 220 may operate in the electronic device 200 as a client application hosted by the electronic device 200, as is shown in FIG. 2. In an alternative embodiment, the policy management module 220 may be provided by and integrated within the operating system 201 of the electronic device 200. In either of the embodiments, the policy management module 220 may be configured to manage the creating and applying of policies described herein. In another embodiment, the policy management module 220 may operate on a server in communication with the electronic device 200.

One example of applications 202 and 203 may be a client application, also referred to as an agent. In embodiments, the client application may monitor connections being made via VPN APIs on, e.g., a mobile device (or other client device such as a laptop or other personal computer), to observe packets, connection endpoints (IP addresses), and the like. In such embodiments, the client application operating on device 200 is intercepting the DNS requests coming from applications on the device and then communicating to a server (e.g., the server hosting the software gateway).

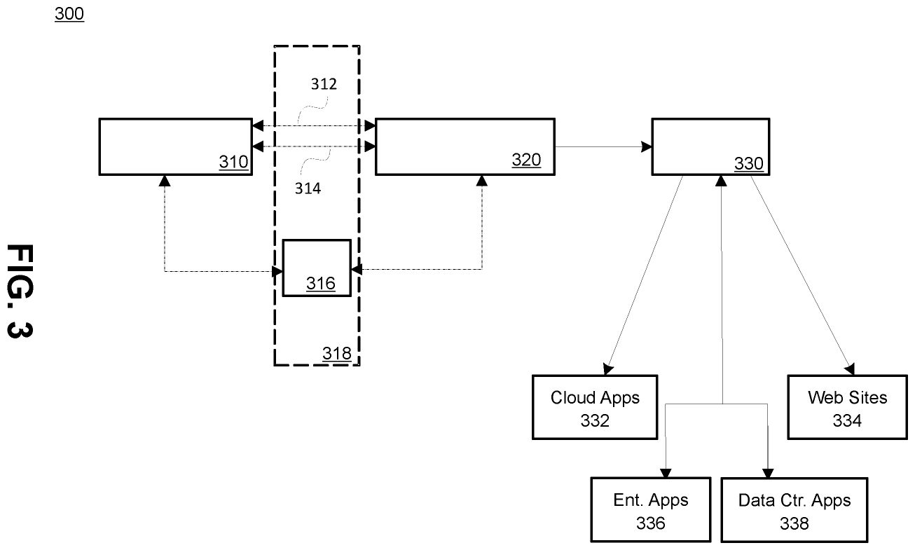

FIG. 3 illustrates a block diagram of a system 300 that uses a software gateway to protect user privacy at the enterprise level in accordance with some embodiments. The exemplary system 300 includes a client device 310 in communication with software gateway server 320 over a network connection, where the software gateway is executed on the software gateway server 320. Block 318 includes alternative methods by which network communication data requests from client device 310 may be routed to software gateway server 320. Channel 312 may represent use of a software gateway client, installed as an application on the client device 310 as described above. Channel 314 may represent use of a proxy auto-configuration (PAC) module by the client device 310. A third alternative channel of routing network communication data requests to the software gateway server 320 may entail use of a reverse proxy server 316, as is discussed further herein.

software gateway server 320 may act as an adblocker and privacy protector for one or more client devices 310, regardless of the client devices being remote to any local network including software gateway server 320. Traffic that may be filtered may include web traffic, firewall traffic, and/or cloud service traffic. This is a significant improvement to conventional firewall technologies, which act only to filter network communications by devices on the same local network as the firewall. The software gateway can use the privacy policies defined by the organization (for enterprise-wide protection) or can be selected by the user of the client device 310. Alternatively, the privacy policy can also be based on-location, and be set by user of a console in communication with software gateway server 320. For blocking ads and trackers, the software gateway can use available open-source databases used for selecting and blocking ads. Additionally, the ad blocking database used by the software gateway can also be developed as a proprietary or can be bought from other vendors to include anti-phishing and anti-malware controls.

In addition to communicating with the client device 310, the software gateway server 320 is in communication with proxy server 330. The proxy server 330 may be implemented as a transparent virtual proxy on the software gateway server 320, or on a separate server altogether in various embodiments. The proxy server 330, as is explained in greater detail below, receives the requests for network communication data from the client device 310, and communicates with the one or more sources associated with the requested network communication data. As shown in system 300, these sources may include Internet-based web sites 334, enterprise applications 336, data center-based applications 338, and cloud applications 332. While exemplary payment message system 300 is shown as having a single software gateway server 320 and a single proxy server 330, the invention is not limited in this regard, as each depicted server may include a network of multiple servers.

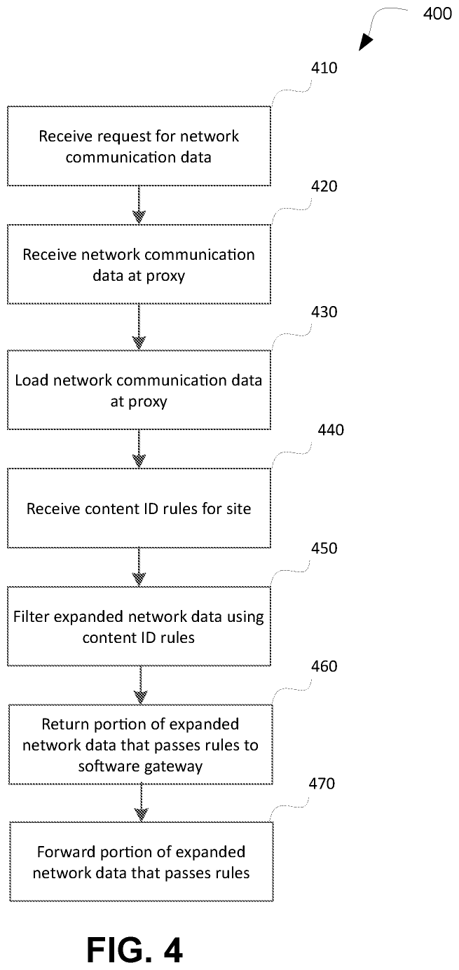

FIG. 4 illustrates a flow diagram of an example method 400 of providing enterprise-level protection of user privacy using the system 300 in accordance with some embodiments. The method 400 may start at step 410, where the software gateway server 320 may receive a request for network communication data from a specified web site from client device 310. The network communication data may be sent via any client application, including browser applications, cloud-based web applications, operating system components/drivers, and/or data center applications, as shown in system 300. As is also shown in system 300, any suitable mechanism may be used to intercept and divert the request for network communication data to the software gateway server 320. First, the request may be received by the software gateway directly from a network-based software client executing on the client device 310, shown by channel 312. The software client may intercept network communication data requests from the client device, where the network communication data requests may originate from a web browser, or from dedicated desktop or mobile applications running on the client device 310.

In another embodiment, a PAC file can be installed on the client device 310 instead of using the software client directly, depicted as channel 314 between the client device 310 and the software gateway server 320. This PAC file (often combined with the installation of a certificate on the client device 310) can be used in tandem with the client device's operating system proxy settings. By overriding the operating system's proxy settings, all traffic may be forced through the software gateway server 320 to proxy server 330. The proxy server 330 will have the ability to inspect the destination network communication data, determine applicable content to remove, remove the content, and then present the allowed portion of the network communication data to the user.

In a third embodiment, the proxying functions may be performed using a ‘reverse proxy’ configuration. In such embodiments, the user or the software client may direct the browser of client device 310 to a reverse proxy website, which may present a portal where any subsequent requests for network communications data via the reverse proxy website are sent to reverse proxy server 316. The reverse proxy server 316 may then forward the requests to SWB server 320, and results after processing are sent back to the user's client browser. In addition to the aforementioned three mechanisms, other mechanisms, such as a software-defined wide-area network may be used to divert the requests for network communication data as needed.

Returning to method 400, the software gateway may transmit the request for network communication data to the specified web site on the behalf of the client device. The network communication data may be received at a proxy server in communication with the software gateway server at step 420 from the specified web site. The software gateway and/or proxy server may be configured to transmit the request to the specified web site using a plurality of different access methods. In addition to using HTTP or HTTPS to access web sites, APIs may be utilized to access web applications via browser or via a dedicated application, which may include using cloud access security brokers (CASBs). Furthermore, when accessing enterprise applications or data center applications, zero trust network access protocols may be used by the software gateway to retrieve the network communications data.

Upon receiving the requested network communications data, the proxy server 330 may load the network communication data to generate expanded network data that includes all content elements of an interface displayable on a display of the client device at step 430 and unseen content elements providing functionality within the web page associated with the requested network communications data (such as fingerprinting data). In addition to rendering the content of the requested network communication data, the executing the software modules may include loading ad content, and loading cookies associated with the network communication data. The cookies may include data that usually is not considered ad content, such as trackers associated with usage of the web site/application, enterprise application, and/or data center application, that nonetheless can be adverse to a user's privacy preferences and/or performance of the client device. The expanded network data may include all of the results of the executing the software modules.

To improve privacy of the user of the client device, the proxy server 330 may then receive a set of content identification rules linked to the specified web site from the server executing the software gateway at step 440. The set of content identification rules may include rules provided by one of, or both an enterprise entity managing the server executing the software gateway and a user of the client device. The content identification rules each specify data that is not passed to the client device, where the content identification rules specify at least one of audiovisual content, advertisements, trackers, or cookies to be blocked.

The proxy server may then filter the expanded network data by applying the set of content identification rules at step 450. For example, the content identification rules may include a rule preventing advertisement data from being transmitted to the client device provided by the enterprise entity for all users associated with the enterprise entity. The proxy server may identify the advertisement data by comparing the expanded network data to a stored list of known, enterprise-defined advertisement sources. When a match is found, the proxy server may prevent the portions of the expanded network data associated with an advertisement source from the enterprise-defined list of advertisement sources being transmitted to the client device when the filtered expanded network data is forwarded to the client device. Other content identification rules may target cross-site tracking code in the expanded network data to prevent unwanted tracking of user behavior.

Other content identification rules may pertain to form fields in the expanded network communication data. There may be content identification rules that remove form fields from the expanded network content, thereby precluding a user from providing any personal information in some embodiments. Form fields may alternatively be allowed initially by the content identification rules; however any user input data subsequently received from the client device for the form fields may be intercepted by the proxy server prior to relaying the user input data to the specified web site. One or more content identification rules (which may be associated with a higher-scrutiny content retrieval policy, discussed further below) may cause the received input data to be substituted for dummy data. The dummy data may include any suitable data that obscures or encrypts the received input data, including randomly-generated character strings, character strings that is determined to be similar to expected personal information data (based on the type of form field), scrambled or encrypted versions of the received user input data, for example. The dummy data may then be transmitted to the specified web site instead of the user input data, thereby providing greater privacy from tracking.

After the content identification rules remove the specified data from the expanded network data, only the portion of the executed network data allowed by the set of content identification rules is then transmitted back to the software gateway server by the proxy server at step 460. The portion of the expanded network data allowed by the content identification rules is then transmitted to the client device by the software gateway via the software client to be displayed in any one of a plurality of client applications executable on the client device at step 470.

In addition to direct filtering by the proxy server 330, the filtering by the content identification rules may be implemented in other ways. In some embodiments, the filtering may be handled by use of APIs in communication with the specified web site, including APIs with cloud access security brokers. The content identification rules may include a set of privacy preferences, which may be sent via the API to the specified web site to match site preferences offered by the specified web site, for example. In other embodiments, the proxy server may transmit a plurality of permission choices in response to a plurality of permissions requests made by the specified web site. The permission choices may be retrieved from a permissions policy object associated with the specified web site that is stored alongside the content identification rules. The permissions policy object may take the form, for example, of a pop-up window providing a plurality of choices with regard to privacy preferences, which may receive user inputs selecting which options are desired. The permissions policy objecty may be received by the proxy server from the server executing the software gateway, similarly to the content identification rules. Privacy may further be enhanced by the proxy server identifying and summarizing site policy changes. In some embodiments, the proxy server may receive an updated privacy policy from the specified web site along with the requested network communications data. In response to receiving the updated privacy policy, the proxy server may determine differences between the updated privacy policy and a prior privacy policy based on a logged most-recent visit to the specified web site (which may be also received from the software gateway, along with the content identification rules). The determined differences may be extracted and summarized by the proxy server, and a summary of the differences may then be transmitted to the client device.

Based on the content identification rules, many different implementations may be utilized to reduce the amount of ad/cookie content transmitted back to the client device in response to the software gateway receiving the request for the network communications data. In an embodiment, the content identification rules may be used to provide “two-sided blocking.” Many websites have “ad-blocker detectors” to prevent a user accessing the website if ads are blocked. The “two sided blocking” approach eliminates this problem, because to the source of the network communications data, it looks as if all ads are being requested and served, as no ad serving domains or URLs are being blocked by the proxy server 330. This is due to the fact that the proxy server 330 is actually requesting and fetching (and for scripts, executing the content) all modules within the network communications content. But the proxy does not serve those ads back to the client device, so from the perspective of the user of the client device 310, all ads have been blocked (and from the perspective of the sources of the network communications data, all ads have been served, so no ad-blocker-blocker behavior is triggered). In an embodiment, the user and/or enterprise administrator have the option to specify using option (a) block ads at proxy, never fetch; or option (b) use two sided blocking; or option (c) do not block ads at all, on a per-domain basis. This can apply not just to advertisements, but to other trackers or even also to functional components which sometimes also do tracking, such as webpage commenting functionality, video player functionality, form-filling functionality, etc. The content identification rules may identify each of the ads and trackers to block, which the software gateway may identify and then prevent from being passed back to the client device 310.

The content identification rules from the enterprise side may be managed by a console available to a network administrator. A configurable option may be provided where users can help decide which websites can be intercepted by the proxy or not for software gateway. The organization can have some granular level of controls to determine if users can make their own exceptions or not. Users can “request” approval via the software gateway client for specific website exceptions and may be required to provide reasons as to why they want an exception. This gives a balance between enterprise security policies and the user being involved in security decisions. Examples of things which can be blocked via the content identification rules include scripts which perform browser fingerprinting to track users across multiple sites. Behavioral detection of fingerprinting scripts at runtime and blocking at the time of execution based not on domain or URL of script source, but of any script based on behavioral detection of fingerprinting would advantageously provide privacy without relying upon predetermined lists of such scripts.

While the above-described solution contemplates using the software gateway and proxy server 330 to replace conventional ad blocking solutions, in some embodiments they may be used together. For example, the software gateway may provide browser extension management functionality to see what is safe and what is not. For example, proxy server could validate the “health” of a browser extension running on the client device 310, by requesting network content that already has been filtered once by a browser extension, then expanding the network content to check for malicious content within the extension itself or outbound calls the extension makes to determine if traffic behavior is normal or not using enterprise-input identification rules for malicious content and/or tracking scripts/cookies. The checking of “health” may involve monitoring the ongoing behavior of the browser extension to confirm that falling within acceptable enterprise policies. In another embodiment, browser extensions may be used by the proxy server 330 after generating the expanded network content to provide a second layer of filtering of the content provided to the client device 310. In addition to providing this second layer of filtering, an enterprise may benefit from having the ability to vet, to inspect ongoing behavior, to control, to limit these browser extensions in a way that is not possible for management solutions for endpoint browser extensions.

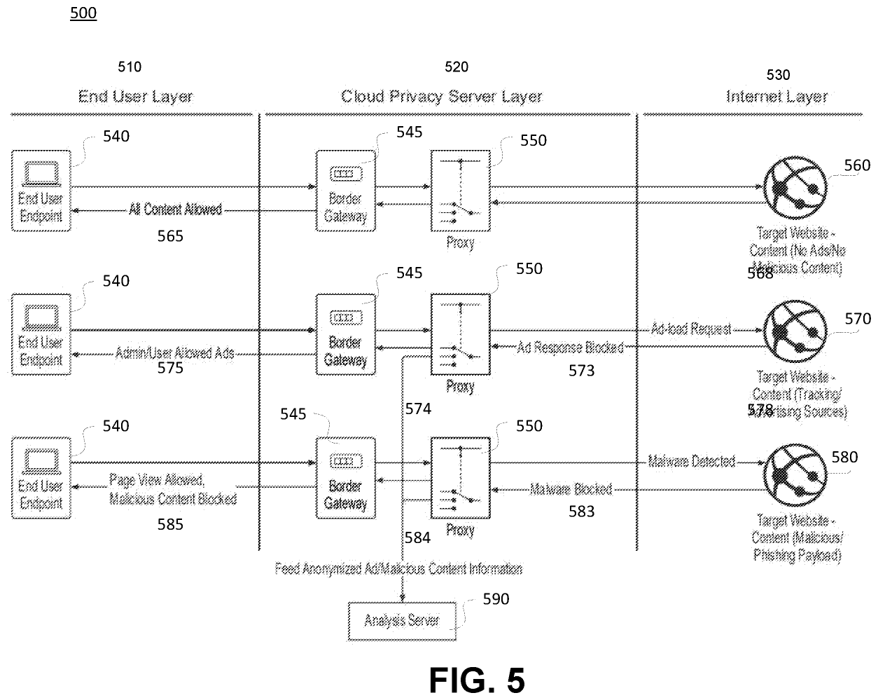

FIG. 5 illustrates a diagram of a system 500 providing enterprise-level protection of user privacy using a software gateway based on several content identification rule configurations, in accordance with some of the above-discussed embodiments of the disclosure. Each example includes the end user layer 510 including the end user endpoint 540, the outgoing request for network communication data, and the received portion of the expanded network data that passes the content identification rules being applied. The request is routed to the software gateway (shown as border gateway 545) and proxy server 550, which may be implemented in different network locations as described above and are located in the cloud privacy server layer 520. The sources of the network communications data may be located in Internet layer 530, and may include the sources shown in FIG. 3 (e.g., web sites, web applications, etc.).

When the source/target network communications data 560 includes no ads, as shown in system 500, all content may be passed back to the end user endpoint 540 (i.e., the client device) using the channel used to transmit the request to the border gateway 545. However, when the network communications data 570 includes ads or tracking data that is identified by one or more of the content identification rules, the proxy server 550 may make an unrestricted request 568 for the network communications data 570 (under the “two-sided blocking” solution described above). The proxy server 550 may apply the content identification rules to block ad and tracker content received in response 573. Only the portion of the expanded network content 575 that is allowed by the content identification rules is passed back to the end user endpoint 540. The blocked material 574 may in some embodiments be transmitted to analysis server 590, to improve content identification rules for example.

Similarly, when the network communications data 580 includes malware or phishing content, the proxy server 550 may make an request 578 for the network communications data 580 (under the block at proxy solution described above) without the malware content, which may be detected using PCP protocols, for example. The proxy server 550 may apply the content identification rules to block ad and tracker content received in response 583, which does not include the detected malware. Only the portion of the expanded network content 585 that is allowed by the content identification rules is passed back to the end user endpoint 540. The blocked material 584 may in some embodiments be transmitted to analysis server 590, to improve content identification rules as described above, for example.

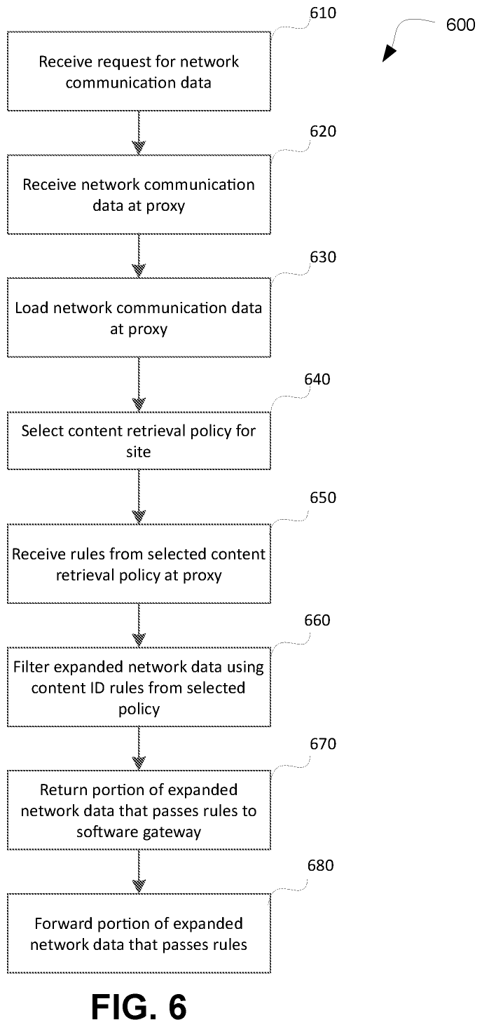

FIG. 6 illustrates a flow diagram of an example method 600 of providing enterprise-level protection of user privacy using different content retrieval policies for a specified web site using a software gateway in accordance with some embodiments. As in method 400, method 600 may start at step 610 with the software gateway server receiving a request for network communication data from a specified web site from client device 310. The specified web site may be associated with two different content retrieval policies by the software gateway in some embodiments. The different content retrieval policies may be unique to the specified web site, or may both be applicable to a grouping of web sites (e.g., social media web sites, or a list of web sites of interest to the enterprise entity). Each content retrieval policy may be provided by an enterprise entity, and the second content retrieval policy for the specified web site may contain more strict content identification rules specifying data that is not passed to the client device than the first content retrieval policy (i.e., may limit a greater amount of content on a site, or may even block the site from being loaded altogether in various embodiments). Each content retrieval policy may include content identification rules as described above, where the content identification rules specify at least one of audiovisual content, advertisements, trackers, or cookies to be blocked.

The software gateway may transmit the request for network communication data to the specified web site on the behalf of the client device, and the network communication data may be received at step 620 from the specified web site. Also, as in method 400, the proxy server 330 may load the network communication data to generate expanded network data that includes all content elements of an interface (such as a web page), which may be displayable or not displayed when the web page is rendered, of the client device at step 630. At step 640, the proxy server 330 may decide which of the two content retrieval policies based on contextual factors. For example, a security alert for the specified web site, indicating that the specified web site has had a security breach event or that the specified web site is no longer trustworthy for any reason, may be a contextual factor that causes the proxy server to select the second content retrieval policy, the stricter of the two, to filter the expanded network data. If no alert has been received, then the first content retrieval policy, which may be a default content retrieval policy for the specified web site, may be selected.

Once the content retrieval policy has been selected, method 600 proceeds similarly to method 400, with the corresponding set of content identification rules from the selected content retrieval policy being received from the server executing the software gateway at step 650. The content identification rules from the selected content retrieval policy may then be used to filter the expanded network communication data at step 660. The portion of the expanded network data allowed by the content identification rules for the selected content retrieval policy may then be transmitted back to the software gateway server at step 670, and forwarded to the client device at step 680 for display.

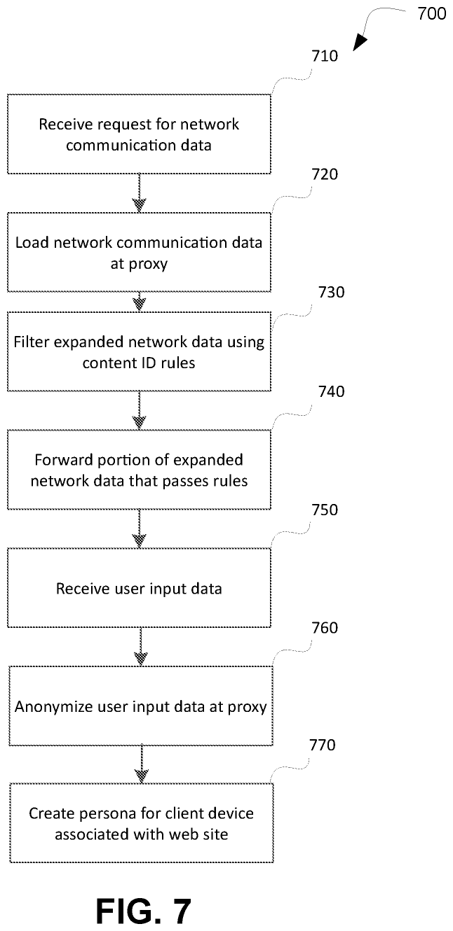

While content identification rules protecting the privacy user input data have been described above, other embodiments go even further to filter and keep users from being tracked. FIG. 7 illustrates a flow diagram of an example method 700 of providing enterprise-level protection of user privacy for user input data directed to a specified web site using a software gateway in accordance with some embodiments. As in method 400, method 700 may start at step 710 with the software gateway server receiving a request for network communication data from a specified web site from client device 310. Also, as in method 400, the proxy server 330 may load the network communication data to generate expanded network data that includes all content elements of an interface displayable on a display of the client device at step 720. The content identification rules linked to the specified web site may then be used to filter the expanded network communication data at step 730. The portion of the expanded network data allowed by the content identification rules for the selected content retrieval policy may then be transmitted back to the software gateway server, and forwarded to the client device at step 740 for display.

At step 750, user input data made up of interactions with the portion of the expanded network data allowed by the content identification rules may be received by the software gateway. The interactions may include data tracked on web sites by cookies, for example, such as user selections or clicks on site elements, time spent on a particular web page, or a browsing history on the specified web site. The software gateway may transmit the user input data to the proxy server, which may be modified to anonymize the user input data prior to transmitting the anonymized user input data to the specified web site at step 760. The anonymizing may be triggered, for example, by the specified web site being one of a plurality of web sites designated by the software gateway for anonymous access (at the behest of the user of the client device, or of the enterprise entity managing the software gateway). The modifications may include anti-tracking measures that modify requests for specific pages within the specified web site to refer to different pages of the specified web site.

In some embodiments, the anonymizing may include creating a dummy identity by the proxy server for use on the specified web site. The dummy identity may have dummy identity information automatically generated by the proxy server, and may allow the anonymized user input data to be linked to the dummy identity by the specified web site. In addition to the web site identity, other factors may trigger anonymizing of user input data. For example, if the user has a selected entity role with the enterprise entity, the software gateway may be configured to change outgoing transmissions (e.g., user input data) to be dissociated with the selected entity role.

Finally, the anonymized user input data may be stored as a persona for the client device, where the persona is associated with the specified web site at step 770. Once the persona for the specified web site has been created, any subsequently-received user input data may be added to a log for the client device of input data sent to all web sites. Having a log of private data-related transmissions by the client device may be useful to an individual user and/or the entity, not only to know what private data has been sent, but also for regulatory purposes. For example, the log may be searchable for a specific piece of input data, and the list of sites to which the input data was sent may be transmitted to the client device on demand by the software gateway.

While the embodiments have been described with regards to particular embodiments, it is recognized that additional variations may be devised without departing from the inventive concept. The terminology used herein is for the purpose of describing particular embodiments only and is not intended to be limiting of the claimed subject matter. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will further be understood that the terms “comprises” and/or “comprising.” when used in this specification, specify the presence of states features, steps, operations, elements, and/or components, but do not preclude the present or addition of one or more other features, steps, operations, elements, components, and/or groups thereof.

Unless otherwise defined, all terms (including technical and scientific terms) used herein have the same meaning as commonly understood by one having ordinary skill in the art to which the embodiments belong. It will further be understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the embodiments, it will be understood that a number of elements, techniques, and steps are disclosed. Each of these has individual benefit and each can also be used in conjunction with one or more, or in some cases all, of the other disclosed elements, or techniques. The specification and claims should be read with the understanding that such combinations are entirely within the scope of the embodiments and the claimed subject matter.

In the description above and throughout, numerous specific details are set forth in order to provide a thorough understanding of an embodiment of this disclosure. It will be evident, however, to one of ordinary skill in the art, that an embodiment may be practiced without these specific details. In other instances, well-known structures and devices are shown in block diagram form to facilitate explanation. The description of the preferred embodiments is not intended to limit the scope of the claims appended hereto. Further, in the methods disclosed herein, various steps are disclosed illustrating some of the functions of an embodiment. These steps are merely examples and are not meant to be limiting in any way. Other steps and functions may be contemplated without departing from this disclosure or the scope of an embodiment.

1. A method comprising:
receiving, by a server executing a software gateway, a request for network communication data from a specified web site, the request being received from a network-based software client executing on a client device, the software client intercepting network communication data requests from the client device;
receiving the network communication data by a proxy server in communication with the server executing the software gateway from the specified web site;
loading, by the proxy server, the network communication data to generate expanded network data, the expanded network data including all content elements of an interface displayable on a display of the client device;
receiving, by the proxy server, a set of site-specific content identification rules linked to the specified web site from the server executing the software gateway in response to receiving the request for the network communication data, the set of content identification rules comprising rules provided by both an enterprise entity managing the server executing the software gateway and a user of the client device, each content identification rule specifying data portions of the expanded network data that are not passed to the client device, the content identification rules specifying at least one of audiovisual content, advertisements, trackers, or cookies to be blocked;
filtering the expanded network data, by the proxy server, by applying the set of content identification rules to the expanded network data, the applying of the rules removing the specified data from the expanded network data;
receiving, by the server executing the software gateway via the proxy server, only a portion of the expanded network data allowed by the set of content identification rules; and
transmitting to the client device, by the software gateway, only the portion of the expanded network data allowed by the set of content identification rules.

2. The method of claim 1, wherein the software client utilizes one of a proxy auto-configuration module or a network connection with a reverse proxy server to intercept and divert all network communication data requests from the client device.

3. The method of claim 1, wherein the content identification rules include a rule preventing advertisement data from being transmitted to the client device, the proxy server identifying the advertisement data by comparing the expanded network data to a stored list of enterprise-defined advertisement sources and preventing portions of the expanded network data from being transmitted to the client device based on the portions originating from the enterprise-defined advertisement sources.

4. The method of claim 1, wherein the network communication data request is from one of a web application or a data center application.

5. The method of claim 1, the filtering the expanded network data being performed via an application programming interface (API) with the specified web site by transmitting a set of preferred privacy settings using the API to the specified web site.

6. The method of claim 1 the filtering the expanded network data further comprising transmitting, by the proxy server, a plurality of permission choices in response to a plurality of permissions requests made by the specified web site, the plurality of permission choices being retrieved from a permissions policy object associated with the specified web site, the permissions policy object being received from the server executing the software gateway.

7. The method of claim 1, further comprising transmitting, by the software gateway server, the portion of the expanded network data allowed by the content identification rules, to the client device via the software client, the portion of the expanded network data allowed by the content identification rules being displayed in any one of a plurality of client applications executable on the client device.

8. The method of claim 1, further comprising receiving, by the proxy server, an updated privacy policy from the specified web site, determining differences between the updated privacy policy and a prior privacy policy based on a logged most-recent visit to the specified web site, and transmitting a summary of the differences to the client device.

9. A method comprising:
receiving, by a server executing a software gateway, a request for network communication data from a specified web site, the request being received from a network-based software client executing on a client device, the software client intercepting network communication data requests from the client device, the software gateway associating two content retrieval policies with the specified web site when the request for network communication data is received, each content retrieval policy being provided by an enterprise entity, where a second content retrieval policy for the specified web site contains more strict content identification rules specifying data portions of expanded network data that are not passed to the client device than a first content retrieval policy, the content identification rules specifying at least one of audiovisual content, advertisements, trackers, or cookies to be blocked;
receiving the network communication data by a proxy server in communication with the server executing the software gateway from the specified web site;
loading, by the proxy server, the network communication data to generate the expanded network data, the expanded network data including all content elements of an interface displayable on a display of the client device;
selecting, by the software gateway, the second content retrieval policy instead of the first content retrieval policy to filter the expanded network data based on the software gateway receiving a security alert for the specified web site;
receiving, by the proxy server, the set of content identification rules included in the second content retrieval policy from the server executing the software gateway;
filtering the expanded network data, by the proxy server, by applying the set of content identification rules from the second content retrieval policy to the expanded network data, the applying of the rules removing the specified data from the expanded network data;
receiving, by the server executing the software gateway via the proxy server, only a portion of the expanded network data that passes the set of content identification rules; and
transmitting to the client device, by the software gateway, only the portion of the expanded network data allowed by the set of content identification rules.

10. The method of claim 9, further comprising:
receiving, from the client device by the software gateway, input data for form fields in the portion of the expanded network data allowed by the set of content identification rules;
substituting the input data from the client device for dummy data in accordance with a rule in the second content retrieval policy; and
transmitting, by the proxy server, the dummy data to the specified web site.

11. The method of claim 9, the content identification rules of the second content retrieval policy including a rule that strips out any form field from the expanded network data.

12. The method of claim 9, the content identification rules of the second content retrieval policy including a rule that strips out any cross-site tracking code from the expanded network data.

13. A method comprising:
receiving, by a server executing a software gateway (SWG), a request for network communication data from a specified web site, the request being received from a network-based software client executing on a client device, the software client intercepting network communication data requests from the client device;
receiving the network communication data by a proxy server in communication with the server executing the software gateway from the specified web site;
loading, by the proxy server, the network communication data to generate expanded network data, the expanded network data including all content elements of an interface displayable on a display of the client device;
receiving, by the proxy server, a set of content identification rules linked to the specified web site from the server executing the software gateway, the set of content identification rules comprising rules provided by both an enterprise entity managing the server executing the software gateway and a user of the client device, each content identification rule specifying data portions of the expanded network data that are not passed to the client device, the content identification rules specifying at least one of audiovisual content, advertisements, trackers, or cookies to be blocked;
filtering the expanded network data, by the proxy server, by applying the set of content identification rules, to the expanded network data, the applying of the rules removing the specified data from the expanded network data;
receiving, by the server executing the software gateway via the proxy server. only a portion of the expanded network data allowed by the set of content identification;
transmitting to the client device, by the software gateway, only the portion of the executed network data allowed by the set of content identification rules;
receiving, by the software gateway, user input data provided by the client device comprising interactions with the portion of the expanded network data allowed by the content identification rules, the user input data being received subsequently to displaying the portion of the expanded network data allowed by the set of content identification rules;
transmitting, by the software gateway, the user input data to the proxy server;
modifying, by the proxy server, the user input data to anonymize the user input data prior to transmitting the anonymized user input data to the specified web site; and
storing, by the proxy server, the anonymized user input data as a persona for the client device associated with the specified web site.

14. The method of claim 13, further comprising adding, by the software gateway, the received user input data to a log of all user input data sent to a plurality of web sites.

15. The method of claim 14, further comprising searching the log of all user input data for selected user data sent to one or more of the plurality of web sites, and transmitting a list of the one or more of the plurality of web sites to the client device.

16. The method of claim 13, further comprising determining, by the software gateway, that the specified web site is one of a plurality of web sites designated for anonymous access, and modifying, by the proxy server, any outgoing transmissions to the specified web site such that any user input data is not identified with the client device.

17. The method of claim 16, further comprising determining, by the software gateway, that the request for the network communication data is associated with a selected entity role, and modifying the outgoing transmissions to change outgoing transmissions to be dissociated with the selected entity role.

18. The method of claim 13, the modifying the user input data to anonymize the user input data including creating a dummy identity, by the proxy server, for use on the specified web site having dummy identity information, and linking the anonymized user input data to the dummy identity.

19. The method of claim 13, wherein the content identification rules include a rule preventing advertisement data from being transmitted to the client device, the proxy server identifying the advertisement data by comparing the expanded network data to a stored list of enterprise-defined advertisement sources and preventing portions of the expanded network data from being transmitted to the client device based on the portions originating from the enterprise-defined advertisement sources.

20. The method of claim 13, further comprising transmitting, by the software gateway server, the portion of the expanded network data allowed by the content identification rules, to the client device via the software client, the portion of the expanded network data allowed by the content identification rules being displayed in any one of a plurality of browser client applications executable on the client device.
